(19) United States
(12) Patent Application Publication
(10) Pub. No.: US 2018/0277001 A1
(43) Pub. Date: Sep. 27, 2018

(54) INTERACTIVE SYSTEM AND METHOD FOR LEARNING A LANGUAGE

(71) Applicant: Zheng Shi, Beijing (CN)

(72) Inventor: Zheng Shi, Beijing (CN)

(21) Appl. No.: 15/989,157

(22) Filed: May 24, 2018

Related U.S. Application Data
(63) Continuation-in-part of application No. PCT/CN2016/106808, filed on Nov. 22, 2016.

(30) Foreign Application Priority Data
Nov. 27, 2015 (CN) 2015108493088

(51) Int. Cl. G09B 5/00; G09B 19/06

(52) U.S. Cl. CPC G09B 5/00; G09B 19/06

(57) ABSTRACT

The present invention provides a system and the accompanying method for learning a language with an interactive board. The system includes multiple physical objects, each embedded with an identifier and marked with a language symbol, an interactive board configured to recognize the identifier information of a physical object placed on the interactive board, a processor operatively connected to the interactive board, a memory unit operatively connected to the processor and configured to store the correlation relationship between identifiers of physical objects and language symbols assigned to physical objects, and a voice input module operatively connected to the processor and configured to receive voice information from a user. Once multiple physical objects are placed on the interactive board, the processor is configured to generate a command instruction for each of the plurality of physical objects, based on the voice information from the user and the identifier information of the physical objects, and to produce a feedback for the user.

### CROSS-REFERENCE TO RELATED APPLICATION

This application is a continuation in part of International Patent Application No. PCT/CN2016/106808, entitled “Interactive System and Method for Learning a Language”, filed on Nov. 22, 2016, which claims priority of Patent Application CN2015108493088, entitled “An Apparatus for Learning a Language with an Interactive Board”, filed on Nov. 27, 2015. The entire disclosure of the above application is incorporated herein by reference.

### TECHNICAL FIELD

The present invention relates to system and method for learning a language, and more particularly, learn an alphabetic language with an interactive board.

### BACKGROUND

Methods allowing children (as well as adults who are learning a new language, illiterate adults, and adults with learning impairments) to read alphabet-based languages by themselves are known. Generally, these methods can be divided into two broad categories: traditional teaching methods that make use of beginner-level reading books and flash cards, and modern teaching techniques that use TV programs, software, web-based materials, or more recently APP-based material.

The traditional methods are time-tested methods for teaching young children alphabet-based languages. These traditional methods also have the benefit of allowing interaction with physical objects, which is something that young children find particularly appealing, as research shows touch is an important aspect of the cognitive development. However, they lack the high level of interactivity that the modern teaching methods can offer.

Computer-based modern teaching methods, which are increasingly run as applications on smart-phones and tablets do allow real-time feedback to any inputs that a learner may choose to make. However, such computer-based modern teaching methods often use screen-based device, which has its disadvantages. Indeed, as parents and teachers are increasingly using computers, touch-screens and smart-phones as educational and entertainment devices for children, children are increasingly exposed to screens from an early age. Many prominent development experts see this as a worrisome trend, and warn that this may have significantly adverse effects on children development.

Therefore, although there are clear benefits for using screen-based computer devices for educating and entertaining children, there are also real health and development costs. Accordingly, it is desirable to provide a new and innovative device that negates the use of screens but maintains the power of computer systems to allow for a greater level of interactivity between the user and the subject being taught. It is also desirable to provide a device that negates the weaknesses of both traditional and modern language teaching methods whilst simultaneously utilizing their respective strengths.

### SUMMARY OF THE INVENTION

Aiming to solve the problems above, the present invention provides a system and the accompanying method for learning a language with an interactive board.

In accordance with one embodiment of the present invention, the system includes multiple physical objects, each embedded with an identifier and marked with a language symbol, an interactive board configured to recognize the identifier information of a physical object placed on the interactive board, a processor operatively connected to the interactive board, a memory unit operatively connected to the processor and configured to store the correlation relationship between identifiers of physical objects and language symbols assigned to physical objects, and a voice input module operatively connected to the processor and configured to receive voice information from a user. Once multiple physical objects are placed on the interactive board, the processor is configured to generate a command instruction for each of the plurality of physical objects, based on the voice information from the user and the identifier information of the physical objects, and to produce a feedback for the user.

In accordance with one embodiment of the present invention, the interactive board includes a sensor array.

In accordance with one embodiment of the present invention, the voice information includes a word in an alphabetic language, and the language symbol includes a letter of the alphabet of the language.

In accordance with one embodiment of the present invention, the interactive board is embedded with indicator lights. The processor is configured to derive letters contained in the word, and to generate the command instruction based on the identifier information of the physical objects placed on the interactive board, to direct the indicator lights underneath each of the physical objects marked with the letters contained in the word to light up sequentially, as the feedback to the user.

In accordance with one embodiment of the present invention, the physical object is embedded with a sensory accessory that might be a vibration module, an LED light, or a buzzer. The processor is configured to derive letters contained in the word, and to generate a command instruction based on the identifier information of the physical objects placed on the interactive board, to direct the sensory accessories embedded in each of the physical objects marked with the letters contained in the word to start up sequentially, as the feedback to the user. And the physical object is further embedded with a microcomputer unit, a wireless communication module and an RF energy harvesting module.

The system and the accompanying method disclosed in the present invention would allow users to interact with the system in a fun and non-restrictive environment and to focus on the learning process in a more intuitive manner.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are only for exemplary embodiments of the present invention, and that a person of ordinary skill in the art may derive additional drawings without deviating from the principles of the present invention.

FIG. 1 is a schematic diagram illustrating the process flow of the system for learning a language with an interactive board in accordance with one embodiment of the invention.

FIG. 2 is an exemplary schematic diagram of the system for learning a language with an interactive board embedded with indicator lights in accordance with one embodiment of the invention.

FIG. 3 is an exemplary schematic diagram of the system for learning English with objects embedded with sensory accessories in accordance with one embodiment of the invention.

### DETAILED DESCRIPTION OF THE INVENTION

To better illustrate the purpose, technical feature, and advantages of the embodiments of the present invention, various embodiments of the present invention will be further described in conjunction with the accompanying drawings.

While the present invention will be described in connection with various specific embodiments, the invention is not limited to these embodiments. People skilled in the art will recognize that the system and method of the present invention may be used in many other applications. The present invention is intended to cover all alternatives, modifications and equivalents within the spirit and scope of invention, which is defined by the apprehended claims.

The technical scheme in the embodiments of the present invention will be described clearly and completely by reference to the accompanying drawings.

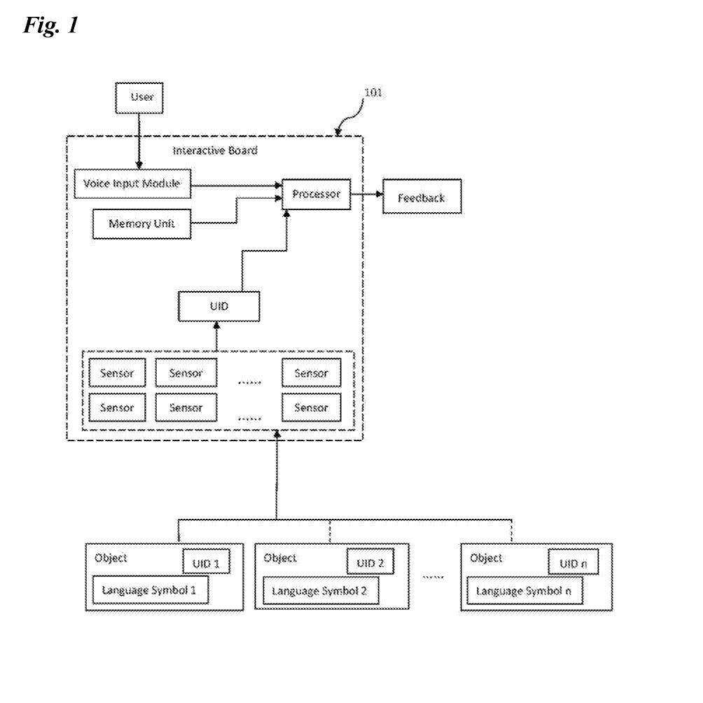

FIG. 1 is a schematic diagram illustrating the process flow of the system for learning a language with an interactive board in accordance with one embodiment of the invention. The system includes multiple physical objects and the interactive board 101. Each physical object is embedded with an identifier and marked with a language symbol. The physical object might be a card, a button, a block, or a sheet. The interactive board 101 is further equipped with a processor, a memory unit and a voice input module. The memory unit is operatively connected to the processor and configured to store the correlation relationship between identifiers of physical objects and language symbols assigned to physical objects. The voice input module is operatively connected to the processor and is configured to receive voice information from a user. The voice input module might be a microphone, a recorder, or any electronic device that has the function of voice input.

The interactive board 101 is configured to recognize the identifier information of a physical object placed on the interactive board. The identifier of a physical object can be defined by a unique identification code (UID), and the UID can be encoded with a radio frequency identification (RFID) chip. The interactive board 101 further includes an array of RF antennas. The array of RF antennas has at least one RF antenna. The interactive board 101 detects the UID of a physical object placed on the board 101 through the wireless communication between the RF chip of the physical object and the RF antennas of the interactive board 101.

The process flow of the system for learning a language with an interactive board provided in the present invention is as follows:

Step 1: placing multiple physical objects on the interactive board 101, and each physical object is embedded with an identifier and marked with a language symbol;

Step 2: recognizing, by the interactive board 101, the identifier information of the physical objects placed on the interactive board 101;

Step 3: receiving, by the voice input module, voice information from a user;

Step 4: generating a command instruction for each of the physical objects, based on the voice information and the identifier information of the physical objects, and producing a feedback for the user, by the processor.

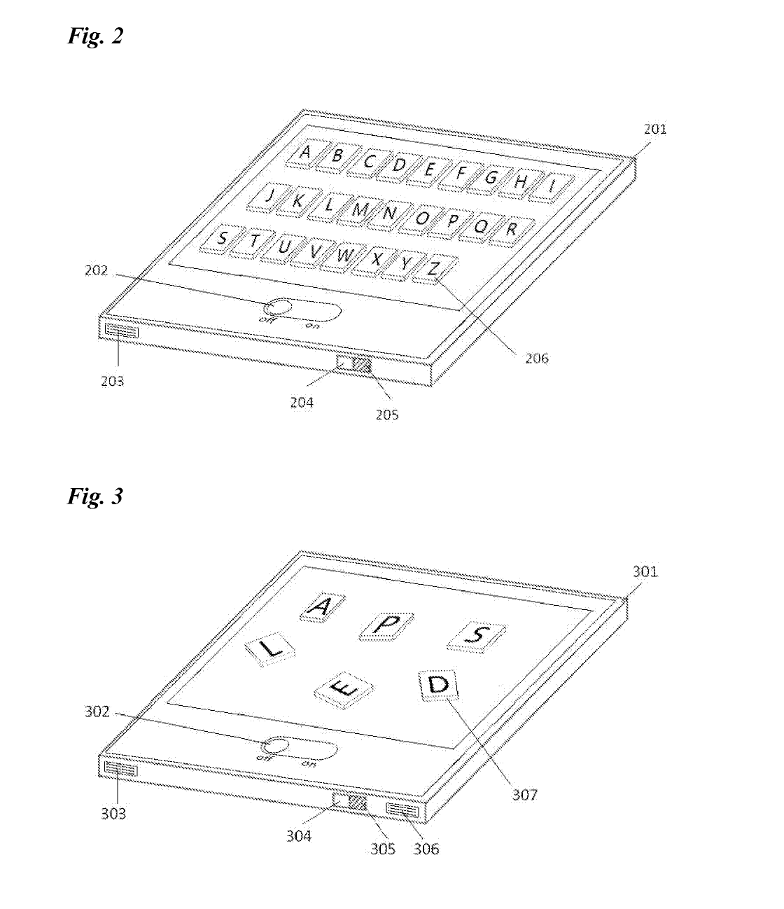

FIG. 2 is an exemplary schematic diagram of the system for learning a language with an interactive board embedded with indicator lights in accordance with one embodiment of the invention. As shown in FIG. 2, the interactive board 201 is embedded with multiple indicator lights. The memory unit 205 stores the correlation relationship between the identifiers of the cards 206 and the language symbols assigned to the cards 206. The language symbols marked on the cards 206 are English letters in this embodiment. Once multiple cards 206 are placed in the functioning area of the interactive board 201, the interactive board 301 recognizes the identifier information of these cards 206. And once the status of the button 202 is switched from “off” to “on”, the voice control function of the system is activated, and the voice input module 203 receives from a user the voice information such as a single English word “BIRD”. The processor 204 derives the four letters B, I, R, D contained in the word “BIRD” and generates a command instruction based on the identifier information of the cards 206 marked with these letters, to direct the indicator lights underneath these cards 206 to light up in the sequence of B-I-R-D, as the feedback to the user. Specifically, the card 206 marked with the letter “B” lights up first, then does the one marked with “I”, “R”, “D”. If the processor 204 can't recognize the letters contained in a word, an error messages will be provided to the user.

For the sake of illustration, both the system and the method described in FIG. 2 are designed specifically for learning English spelling, but any person skilled in the art will recognize that this embodiment can also be applicable to all alphabetic languages in which symbols reflect the pronunciation of words. Examples of alphabetic languages include English, Greek, Russian, Thai, Arabic, and Hebrew, etc.

FIG. 3 is an exemplary schematic diagram of the system for learning English with objects embedded with sensory accessories in accordance with another embodiment of the invention. The interactive board 301 is further embedded with a wireless communication module 306. The correlation relationship between identifiers of the physical objects 307 and English letters assigned to the physical objects 307 is stored in the memory unit 305. Each physical object 307 is embedded with a sensory accessory that might be a vibration module, an LED light, or a buzzer. In this embodiment, the sensory accessory is a vibration module. And each physical object 307 is further embedded with a microcomputer unit, a wireless communication module and an RF energy harvesting module. The processor 304 controls the physical objects 307 through the wireless communication between the wireless communication modules embedded in each physical object 307 and the interactive board 301. For each physical object 307, the microcomputer unit is used to control the vibration module, and the RF energy harvesting module is used to provide energy for the microcomputer unit and the vibration module.

As shown in FIG. 3, multiple physical objects 307 are placed in the functioning area of the interactive board 301 which then recognizes the identifier information of these cards 307. Once the status of the button 302 is switched from “off” to “on”, the voice control function of the system is activated, and the voice input module 303 receives from the user the voice information such as a single English word “APPLE”. The processor 304 derives the letters A, P, P, L, E contained in the word “APPLE” and generates a command instruction based on the identifier information of the objects 307 marked with these letters, to direct the vibration module embedded in each of the physical objects marked with the letters to operate in the sequence of A-P-P-L-E, as the feedback to the user. Specifically, the object 307 marked with the letter “A” vibrates first, then does the one marked with “P”, “P”, “L”, “E”. If the processor 304 can't recognize the letters contained in a word or no objects are available on the interactive board 301, an error messages will be provided to the user.

1. A system for learning a language with an interactive board, comprising:
a plurality of physical objects, each embedded with an identifier and marked with a language symbol;
an interactive board, configured to recognize the identifier information of a physical object placed on the interactive board;
a processor operatively connected to the interactive board;
a memory unit operatively connected to the processor and configured to store the correlation relationship between identifiers of physical objects and language symbols assigned to physical objects;
a voice input module operatively connected to the processor and configured to receive voice information from a user;
wherein, upon a plurality of physical objects having been placed on the interactive board, the processor is configured to generate a command instruction for each of the plurality of physical objects, based on the voice information from the user and the identifier information of the physical objects, and to produce a feedback for the user.

2. The system of claim 1, wherein the interactive board further comprises a sensor array.

3. The system of claim 1, wherein the voice information comprises a word in an alphabetic language, and the language symbol comprises a letter of the alphabet of the language.

4. The system of claim 3, wherein the interactive board is further embedded with indicator lights.

5. The system of claim 4, wherein the processor is further configured to derive letters contained in the word, and to generate the command instruction based on the identifier information of the physical objects placed on the interactive board, to direct the indicator lights underneath each of the physical objects marked with the letters contained in the word to light up sequentially, as the feedback to the user.

6. The system of claim 3, wherein the physical object is further embedded with a sensory accessory selected from a group consisting of a vibration module, an LED light, and a buzzer.

7. The system of claim 6, wherein the processor is further configured to derive letters contained in the word, and to generate a command instruction based on the identifier information of the physical objects placed on the interactive board, to direct the sensory accessories embedded in each of the physical objects marked with the letters contained in the word to start up sequentially, as the feedback to the user.

8. The system of claim 7, wherein the physical object is further embedded with a microcomputer unit, a wireless communication module and an RF energy harvesting module.

9. A method for learning a language with an interactive board, comprising:
placing a plurality of physical objects upon an interactive board, with each physical object embedded with an identifier and marked with a language symbol;
recognizing, by the interactive board, the identifier information of the physical objects placed on the interactive board;
receiving, by a voice input module, voice information from a user; and
generating, by a processor operatively connected to the interactive board, a command instruction for each of the plurality of physical objects, based on the voice information from the user and the identifier information of the physical objects, wherein the correlation relationship between identifiers of physical objects and language symbols assigned to physical objects is stored in a memory unit, and wherein the voice input module and the memory unit are operatively connected to the processor.

10. The method of claim 9, wherein the interactive board further comprises a sensor array.

11. The method of claim 9, wherein the voice information comprises a word in an alphabetic language, and the language symbol comprises a letter of the alphabet of the language.

12. The method of claim 11, wherein the interactive board is further embedded with indicator lights.

13. The method of claim 12, further comprising, deriving letters contained in the word, and generating the command instruction based on the identifier information of the physical objects placed on the interactive board, to direct the indicator lights underneath each of the physical objects marked with the letters contained in the word to light up sequentially, as the feedback to the user, by the processor.

14. The method of claim 11, wherein the physical object is further embedded with a sensory accessory selected from a group consisting of a vibration module, an LED light, and a buzzer.

15. The method of claim 14, further comprising, deriving letters contained in the word, and generating a command instruction based on the identifier information of the physical objects placed on the interactive board, to direct the sensory accessories embedded in each of the physical objects marked with the letters contained in the word to start up sequentially, as the feedback to the user, by the processor.

16. The method of claim 15, wherein the physical object is further embedded with a microcomputer unit, a wireless communication module and an RF energy harvesting module.
